(19) United States
(12) Patent Application Publication
(10) Pub. No.: US 2026/0245882 A1
(43) Pub. Date: Aug. 20, 2026

(54) Lithium Oxide Cathode and Lithium-Ion Battery Comprising the Same

(71) Applicant: Academia Sinica, Taipei City (TW)

(72) Inventors: Maw-Kuen WU, Taipei City (TW); Wei-Ming CHEN, Taipei City (TW); Hsin-Yu HSIEH, Taipei City (TW); Po-Wei CHI, Taipei City (TW); Phillip M WU, Taipei City (TW)

(21) Appl. No.: 19/054,069

(22) Filed: Feb. 14, 2025

(51) Int. Cl. H01M 4/505; H01M 4/02; H01M 4/131; H01M 4/36; H01M 10/0525

(52) U.S. Cl. CPC H01M 4/505; H01M 4/131; H01M 4/366; H01M 10/0525; H01M 2004/021; H01M 2004/028

(57) ABSTRACT

A lithium oxide cathode for a lithium-ion battery includes: a current collector; and a cathode material layer disposed on the current collector and comprising a cathode material, a first metal oxide deposited on the cathode material, and a second metal oxide deposited on the first metal oxide, wherein the cathode material is a lithium oxide cathode material, the first metal oxide comprises Al₂O₃, and the second metal oxide comprises TiO₂, V₂O₅, ZrO₂, ZnO or a combination thereof.

### BACKGROUND OF THE INVENTION

### Field

The present invention relates to a lithium oxide cathode and lithium-ion battery comprising the same. More specifically, the present invention relates to a lithium-rich layered oxide (LLO) cathode and lithium-ion battery comprising the same.

### Description of Related Art

In recent years, there has been a notable increase in the adoption of electric vehicles (EVs) and hybrid electric vehicles (HEVs) so that rechargeable lithium-ion batteries (LIBs) have become widely utilized in public transportation. With the increasing demands in the transportation sector, studies on rechargeable lithium-ion batteries (LIBs) with the aim of achieving extended longevity and enhanced energy storage capacity have become an important research topic. Fundamentally, the energy storage capacity of LIBs hinges on the difference in lithium chemical potential and the reversible capacity between the anode and cathode. However, in comparison to the anode, contemporary cathodes employed in mass-produced LIBs typically exhibit lower capacity. Over the past few decades, various cathode materials, including LiCoO₂ and LiMnO₂, layer-structured LiNi₁₋ₓCoₓO₂, spinel-structured LiMn₂O₄ and LiNi_{0.5}Mn_{1.5}O₄, and olivine-structured LiFePO₄ have been developed for practical applications. However, the overall energy storage capacity of these batteries often faces limitations.

Achieving greater energy storage capacity and the ability to deliver more power in LIBs is crucial. Therefore, it is desirable to provide a novel cathode material with higher specific capacities.

### SUMMARY OF THE INVENTION

An aspect of the present invention is to provide a lithium oxide cathode for a lithium-ion battery, comprising: a current collector; and a cathode material layer disposed on the current collector and comprising a cathode material, a first metal oxide deposited on the cathode material, and a second metal oxide deposited on the first metal oxide, wherein the cathode material is a lithium oxide cathode material, the first metal oxide comprises Al₂O₃, and the second metal oxide comprises TiO₂, V₂O₅, ZrO₂, ZnO or a combination thereof.

Another aspect of the present invention is to provide a lithium-ion battery, comprising: the aforesaid lithium oxide cathode; an anode disposed opposite to the lithium oxide cathode; a separator disposed between the lithium oxide cathode and the anode; and an electrolyte disposed between the lithium oxide cathode and the anode.

The details of one or more embodiments of the invention are set forth in the description below. Other features, objects, and advantages of the invention will be apparent from the description and from the claims.

### BRIEF DESCRIPTION OF DRAWINGS

FIG. 1 is a cross-sectional view of a lithium-ion battery of the present invention.

FIG. 2 is a schematic diagram showing a cathode material layer of a lithium oxide cathode of the present invention.

FIG. 3A shows the TEM image of the cathode material layer of Example 1.

FIG. 3B shows the TEM image of the cathode material layer of Example 2.

FIG. 4A shows initial charge/discharge curves of AS200, TAA-3/AS200, and TAA-5/AS200 electrodes.

FIG. 4B shows the corresponding histograms of the first charge, discharge, and irreversible capacity loss at 0.1C rate of AS200, TAA-3/AS200, and TAA-5/AS200 electrodes.

FIG. 4C shows the cycle performance tested within the voltage range of 2.2 to 4.6 V at a rate of 0.1C of AS200, TAA-3/AS200, and TAA-5/AS200 electrodes.

FIG. 4D shows rate performances of AS200, TAA-3/AS200, and TAA-5/AS200 electrodes from 0.1 to 10C rate during 2.2 to 4.6 V.

FIG. 5A shows the comparative rate performance of AS200, 3 nm-TiO₂/AS200, 3 nm-Al₂O₃/AS200, and TAA-3 electrodes under varying C-rates, with a potential range from 2.2 V to 4.6 V.

FIG. 5B shows the comparative rate performance of AS200, 5 nm-TiO₂/AS200, 5 nm-Al₂O₃/AS200, and TAA-5 electrodes under varying C-rates, with a potential range from 2.2V to 4.6V.

FIG. 6 shows cycling performance comparison of AS200, TAA-3, and TAA-5 electrodes under 1 C, with a potential range spanning from 2.2V to 4.6V.

FIG. 7A to FIG. 7C respectively show the voltage versus normalized capacity curves for the AS200, TAA-3/AS200, and TAA-5/AS200 electrodes.

FIG. 7D to FIG. 7F respectively show the differential capacity (dQ/dV) plots for the AS200, TAA-3/AS200, and TAA-5/AS200 electrodes.

FIG. 8A to FIG. 8C respectively show the EIS spectra of AS200, TAA-3/AS200, and TAA-5/AS200 electrodes recorded at 3.8 V with frequency ranging from 100 kHz to 0.1 Hz over 0 to 100 cycles.

FIG. 8D to FIG. 8F respectively show the corresponding DRT plots for AS200, TAA-3/AS200, and TAA-5/AS200 electrodes.

FIG. 9A shows the cycle performance tested within the voltage range of 3.0V to 4.95V at a rate of 0.1C of NCM333 and TiO₂/Al₂O₃/NCM333 5 nm electrodes.

FIG. 9B shows rate performances of NCM333 and TiO₂/Al₂O₃/NCM333 5 nm electrodes from 0.1 to 10C rate during 2.2 to 4.6 V.

FIG. 10 shows the cycle performance tested within the voltage range of 3.0V to 4.95V at a rate of 0.1C of LNMO and TiO₂/Al₂O₃ 2:1 LNMO electrodes.

### DETAILED DESCRIPTION OF THE INVENTION

Disclosed in detail below is a lithium oxide cathode for a lithium-ion battery, comprising: a current collector; and a cathode material layer disposed on the current collector and comprising a cathode material, a first metal oxide deposited on the cathode material, and a second metal oxide deposited on the first metal oxide, wherein the cathode material is a lithium oxide cathode material, the first metal oxide comprises Al₂O₃, and the second metal oxide comprises TiO₂, V₂O₅, ZrO₂, ZnO or a combination thereof.

Also disclosed in detail below is a lithium-ion battery, comprising: the aforesaid lithium oxide cathode; an anode disposed opposite to the lithium oxide cathode; a separator disposed between the lithium oxide cathode and the anode; and an electrolyte disposed between the lithium oxide cathode and the anode.

In one embodiment, the current collector is an aluminum foil, but the present invention is not limited thereto. The current collector used in the electrode of the present invention may be any other known current collector used in the art, such as a copper foil.

In one embodiment, the anode is a lithium metal anode. However, the present invention is not limited thereto, and any other known anode may be used in the present invention.

In one embodiment, the separator may be a polypropylene separator, a polyethylene separator or a combination thereof. However, the present invention is not limited thereto, and any other known separator may be used in the present invention.

In one embodiment, the first metal oxide may comprise Al₂O₃, and the second metal oxide may comprise TiO₂, V₂O₅, ZrO₂, ZnO or a combination thereof. In one embodiment, the first metal oxide may comprise Al₂O₃, and the second metal oxide may comprise TiO₂, V₂O₅, ZrO₂ or ZnO. In one embodiment, the first metal oxide may comprise Al₂O₃, and the second metal oxide may comprise TiO₂.

In one embodiment, the first metal oxide and the second metal oxide may be respectively formed by atomic layer deposition (ALD). In one embodiment, the first metal oxide of Al₂O₃ is formed by ALD, and the second metal oxide of TiO₂ is also formed by ALD.

In one embodiment, a thickness of the first metal oxide may range from 0.5 nm to 5 nm, for example, 0.5 nm to 4.5 nm, 0.5 nm to 4 nm, 0.5 nm to 3.5 nm, 0.5 nm to 3 nm, 1 nm to 3 nm, 1 nm to 2.5 nm, 1.5 nm to 3 nm or 1.5 nm to 2.5 nm.

In one embodiment, a thickness of the second metal oxide may range from 0.5 nm to 5 nm, for example, 1 nm to 5 nm, 1 nm to 4.5 nm, 1 nm to 4 nm, 1.5 nm to 4 nm or 1.5 nm to 3.5 nm.

In one embodiment, a sum of the thickness of the first metal oxide and the thickness of the second metal oxide may range from 1 nm to 10 nm, for example, 1 nm to 9 nm, 1 nm to 8 nm, 1 nm to 7 nm, 2 nm to 7 nm, 2 nm to 6 nm, 3 nm to 6 nm or 3 nm to 5 nm. In one embodiment, the sum of the thickness of the first metal oxide and the thickness of the second metal oxide may be about 3 nm. In one embodiment, the sum of the thickness of the first metal oxide and the thickness of the second metal oxide may be about 4 nm. In one embodiment, the sum of the thickness of the first metal oxide and the thickness of the second metal oxide may be about 5 nm.

In one embodiment, the ratio of the thickness of the first metal oxide to the thickness of the second metal oxide is not particularly limited, and may be, for example, 1:5 to 5:1, 1:4 to 4:1, 1:3 to 3:1, 1:2 to 2:1 or 1:1.5 to 1.5:1. In one embodiment, the ratio of the thickness of the first metal oxide to the thickness of the second metal oxide may be about 1:1. In one embodiment, the ratio of the thickness of the first metal oxide to the thickness of the second metal oxide may be about 1:2.

In one embodiment, the cathode material may have a chemical formula of LiₐNi_{b}Co_{c}Mn_{d}O₂, wherein 0.9≤a≤1.1, 0.3≤b≤0.5, 0.01≤c≤0.5, and 0.3≤d≤0.6.

In one embodiment, the cathode material may have a chemical formula of LiₐNi_{b}Co_{c}Mn_{d}O₂, wherein 0.9≤a≤1.1, 0.3≤b≤0.5, 0.01≤c≤0.15, and 0.4≤d≤0.6. In one embodiment, the cathode material may be Li_{1.08}Ni_{0.34}Co_{0.08}Mn_{0.5}O₂.

In one embodiment, the cathode material may have a chemical formula of LiₐNi_{b}Co_{c}Mn_{d}O₂, wherein 0.9≤a≤1.1, 0.3≤b≤0.5, 0.3≤c≤0.5, and 0.3≤d≤0.5. In one embodiment, the cathode material may be Li₁Ni_{1/3}Co_{1/3}Mn_{1/3}O₂.

In one embodiment, the cathode material may have a chemical formula of LiₓNi_{y}Mn_{z}O₄, wherein 0.9≤x≤1.1, 0.3≤y≤0.8, and 1.2≤z≤1.7. In one embodiment, the cathode material may be LiNi_{0.5}Mn_{1.5}O₄.

In one embodiment, the cathode material may further comprise a conductive additive. The conductive additive may be any known conductive additive used in the art, such as metal particles, conductive metal oxides, carbon black (for example, conductive carbon or acetylene black), carbon nanotubes, graphite, carbon nanofibers, other conductive materials or a combination thereof, but the present invention is not limited thereto.

In one embodiment, an amount of the conductive additive may range from 1 wt % to 10 wt %, such as 1 wt % to 9 wt %, 2 wt % to 9 wt %, 2 wt % to 8 wt %, 3 wt % to 8 wt %, 3 wt % to 7 wt %, 4 wt % to 7 wt % or 4 wt % to 6 wt %, based on a total weight of the cathode material. In one embodiment, the amount of the conductive additive is about 4 wt % based on the total weight of the cathode material. However, the present invention is not limited thereto, and the amount of the conductive additive may be adjusted according to the needs.

In one embodiment, the cathode material may further comprise a binder. The binder may be any known binder used in the art, such as polyvinylidene fluoride (PVDF), styrene-butadiene rubber latex (SBR), sodium carboxymethyl cellulose (CMC), other binders or a combination thereof, but the present invention is not limited thereto.

In one embodiment, an amount of the binder may range from 3 wt % to 10 wt %, such as 3 wt % to 9 wt %, 3 wt % to 8 wt %, 3 wt % to 7 wt %, 4 wt % to 7 wt % or 4 wt % to 6 wt %, based on a total weight of the cathode material. In one embodiment of the present invention, the amount of the binder is about 5 wt % based on a total weight of the cathode material. However, the present invention is not limited thereto, and the amount of the binder may be adjusted according to the needs.

When the lithium oxide cathode of the present invention is used in the lithium-ion battery, the lithium-ion battery exhibits improved discharge capacities, enhanced capacity retention, reduced voltage decay, lower surface film resistance, and improved interfacial charge transfer resistances, contributing to enhanced stability. Thus, the lithium oxide cathode of the present invention exhibit promising potential for advancing the electrochemical performance of lithium-rich layered oxide cathodes in lithium-ion batteries.

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existent of another element described by a smaller ordinal number.

Moreover, in the present specification, the terms, such as “top”, “bottom”, “left”, “right”, “front”, “back”, or “middle”, as well as the terms, such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially means that the elements contact the other element, except otherwise specified. Such interpretation is applied to other cases similar to the case of “on”.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

### EXAMPLE

### AS200 Electrode Preparation

The cathode material, Li_{1.08}Ni_{0.34}Co_{0.08}Mn_{0.5}O₂, was synthesized through a spray pyrolysis process using a 1000 mL aqueous solution containing transition metal nitrates (0.34 M Ni(NO₃)₂, 0.5 M Mn(NO₃)₂, 0.08 M Co(NO₃)₂) as the starting material. The resulting dry powder served as the precursor material. To produce Li_{1.08}[Ni_{0.34}Co_{0.08}Mn_{0.5}]O₂, the precursor was subjected to ball milling along with Li₂CO₃, maintaining a molar ratio of Li:(Ni+Co+Mn) at 1.08:1.00. Subsequently, the mixture was heated under a flow of oxygen gas at 910° C. for 10 h, with a gradual ramp-up of temperature at a rate of 5° C./min. This process ultimately yielded a spherical-shaped stoichiometric cathode material, referred to as AS200.

### NCM333 Electrode Preparation

The cathode material, NCM333 was synthesized through a spray pyrolysis process using a 1000 mL aqueous solution containing transition metal nitrates (0.33 M Ni(NO₃)₂, 0.33 M Mn(NO₃)₂, 0.33 M Co(NO₃)₂) as the starting material. The resulting dry powder served as the precursor material. To produce NCM333, the precursor was subjected to ball milling along with Li₂CO₃. Subsequently, the mixture was heated under a flow of oxygen gas at 880° C. for 6 h, with a gradual ramp-up of temperature at a rate of 5° C./min. This process ultimately yielded a spherical-shaped stoichiometric cathode material.

### LNMO Electrode Preparation

CH₃COOLi·2H₂O, nickel(II) acetate tetrahydrate Ni(CH₃COO)₂·4H₂O, and manganese(II) acetate tetrahydrate Mn(CH₃COO)₂·4H₂O were mixed in the stoichiometric ratio of 1.05:1:1. Then, they were dissolved separately in distilled water with continuous stirring to obtain the solution A. Afterwards, the appropriate amount of adipic acid C₆H₁₀O₄, used as a chelating agent, was dissolved in 100 ml distilled water to obtain the solution B. After the preparation of both solutions, they were mixed and then stirred at 120° C. until the solvent was completely evaporated. The resultant powder was collected and dried at 100° C. for 24 h to completely remove the remaining solvent in the precursor powder. The as-received powder was pre-calcined at 420° C. for 12 h in air atmosphere to remove the organic residues. After that, the resulting powder was grounded by mortar to obtain the fine powder, and subsequently the as-prepared LNMO was calcined at 900° C. in an air atmosphere for 10 h and naturally cooled to room temperature.

TiO₂/Al₂O₃ Bilayered ALD Coating

TiO₂/Al₂O₃ bilayered films were deposited onto AS200 electrodes, NCM 333 electrodes or LNMO electrodes by using the BENEQ TFS 500 atomic layer deposition (ALD) system. To begin, AS200 electrodes, NCM electrodes or LNMO electrodes were prepared by blending the AS200, NCM 333 or LNMO with conductive carbon (KS6 and Super P) and poly(vinylidene fluoride) (PVDF) in weight ratios of 91:2:2:5. Following this, N-Methyl-2-pyrrolidone (NMP) was introduced to create a uniform, black, and viscous slurry. This slurry was evenly coated onto aluminum foil using a doctor blade and subsequently dried under vacuum conditions at 110° C. for a duration of 24 h. Next, the AS200 electrode, NCM 333 electrode or LNMO electrode was placed into the ALD reactor, operated under a base pressure of around 1 mTorr. Here, 1.5 nm (and/or 2.5 nm)-thick Al₂O₃ thin films were first deposited onto the AS200 electrode or NCM333 electrode, and 1.7 nm-thick Al₂O₃ thin films were first deposited onto the LNMO electrode, using ALD cycles with trimethyl aluminum (TMA) and H₂O as precursors at a temperature of 110° C. Subsequently, 1.5 nm (and/or 2.5 nm, and/or 3.4 nm)-thick TiO₂ layers were deposited on top of the Al₂O₃ layer using ALD cycles with titanium tetrachloride (TiCl₄) and H₂O as precursors, still maintaining the deposition temperature at 110° C. Precise control was achieved by setting the precursor dose and purge time for both Al₂O₃ and TiO₂ ALD processes at 0.3 and 0.4 s, respectively, with 2 s N₂ purge applied between each pulse. Furthermore, the growth rate for each Al₂O₃ and TiO₂ layer was maintained at 1 and 1.5 Å/cycle, respectively. This meticulous deposition process resulted in the creation of 3 and 5 nm thick TiO₂/Al₂O₃ bilayered films, denoted as TAA-3 and TAA-5, on the AS200 electrode or NCM333 electrode, and 5 nm thick TiO₂/Al₂O₃ bilayered films, denoted as TiO₂/Al₂O₃ 2:1, on the LNMO electrode.

### Lithium-Ion Battery Assembly and Measuring

CR2032 coin cells were carefully assembled in an argon-filled glovebox (Vigor). All materials used in the assembly process were predried at 110° C. in a vacuum oven. For the half-cells, the following components were utilized: an 013 mm cathode electrode, a lithium-metal anode with a 015 mm diameter, and a polypropylene separator sourced from Celgard Co. in Japan. The separator was soaked with a standard electrolyte solution consisting of 200 μL of a 1.0 M LiPF₆ solution in a 1:1 by weight mixture of ethylene carbonate (EC) and dimethyl carbonate (DMC) obtained from Formosa Co. in Taiwan. To evaluate the electrochemical properties, CR2032-type coin cells were employed with metallic lithium serving as both the counter and reference electrode. Cyclic voltammetry tests were conducted at a scan rate of 0.1 mV s⁻¹ at room temperature using a PARSTAT MC 200 electrochemistry workstation, with the measurement range set between 2.2 and 4.6 V. Charge and discharge profiles were obtained through galvanostatic cycling between 2.2 and 4.6 V vs Li⁺/Li, applying a constant current at a rate of 0.1C at room temperature via a Think Power battery testing system. Electrochemical impedance spectroscopy (EIS) was carried out using the same workstation for the CR2032-type coin cells, applying an AC amplitude of 10 mV. The measurement encompassed a frequency range spanning from 100 kHz to 0.1 Hz. The distribution of relaxation times (DRT) was calculated using DRTtools, based on the Gaussian discretization method with a regularization parameter of 10⁻⁴ and a full width at half-maximum (FWHM) of 0.5. Additionally, the Impedance Spectroscopy Genetic Programming (ISGP) program was utilized for further analysis.

Microstructure analysis was conducted by using a high-resolution transmission electron microscope (TEM, JEOL JEM-2100F). To safeguard the integrity of the TiO₂/Al₂O₃ coating during sample preparation and subsequent processing, a protective layer of platinum was applied. This protective layer was created through an initial electron-beam deposition followed by ion-beam-assisted deposition, employing an SEIKO SMI3050SE Dual-Beam Focused Ion Beam (FIB) instrument. Following the application of a protective layer, TEM specimens were carefully prepared using gallium-focused ion-beam milling techniques.

### Results

FIG. 1 is a cross-sectional view of a lithium-ion battery of the present invention. The lithium-ion battery of the present invention comprises: a lithium oxide cathode 1 comprising a current collector 11 and a cathode material layer 12 disposed on the current collector 11; an anode 2 opposite to the lithium oxide cathode 1; a separator 3 disposed between the lithium oxide cathode 1 and the anode 2; and an electrolyte disposed between the lithium oxide cathode 1 and the anode 2.

In the lithium half cells prepared above, the current collector 11 is an aluminum foil, the anode 2 is a lithium-metal anode, the separator is a polypropylene separator, and the electrolyte is an electrolyte solution containing LiPF₆.

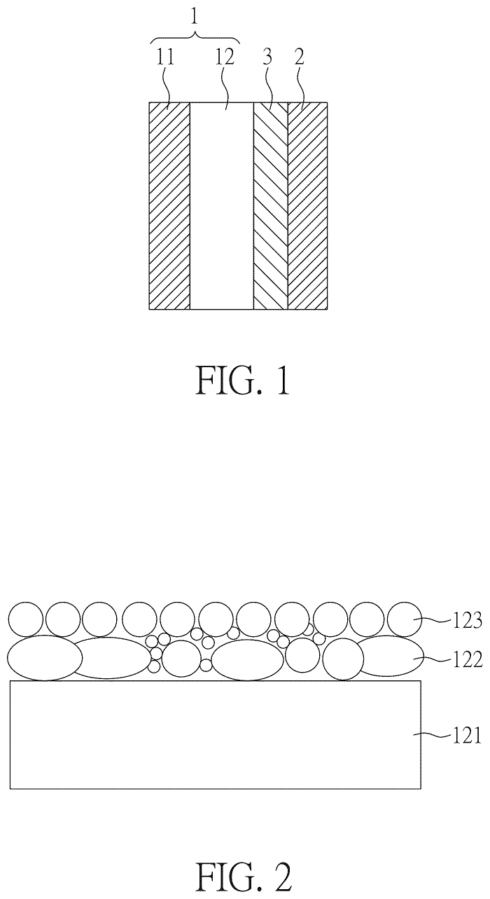

FIG. 2 is a schematic diagram showing a cathode material layer of a lithium oxide cathode of the present invention. The cathode material layer of the lithium oxide cathode of the present invention comprises a cathode material 121, a first metal oxide 122 deposited on the cathode material 121, and a second metal oxide 123 deposited on the first metal oxide 122. Furthermore, the cathode material further comprises conductive carbon and PVDF as a binder.

More specifically, as shown in FIG. 2, the first metal oxide 122 is present in the form of particles, and is formed by ALD and deposited on the cathode material 121. The second metal oxide 123 is present in the form of particles, and is formed by ALD and deposited on first metal oxide 122. In addition, the diameter of the particles of the first metal oxide 122 is greater than the diameter of the particles of the second metal oxide 123, and the particles of the second metal oxide 123 are deposited not only on the particles of the first metal oxide 122 but also between two adjacent particles of the first metal oxide 122.

### Example 1—TAA-3/AS200 Electrode

As shown in FIG. 2, the cathode material 121 comprises Li_{1.08}Ni_{0.34}Co_{0.08}Mn_{0.5}O₂, referred to as AS200. The first metal oxide 122 is a 1.5 nm-thick of Al₂O₃ thin film. The second metal oxide 123 is a 1.5 nm-thick of TiO₂ thin film.

### Example 2—TAA-5/AS200 Electrode

As shown in FIG. 2, the cathode material 121 comprises Li_{1.08}Ni_{0.34}Co_{0.08}Mn_{0.5}O₂, referred to as AS200. The first metal oxide 122 is a 2.5 nm-thick of Al₂O₃ thin film. The second metal oxide 123 is a 2.5 nm-thick of TiO₂ thin film.

### Comparative Example 1—AS200 Electrode

The electrode of the present comparative example is similar to that of Example 1, wherein the cathode material 121 comprises Li_{1.08}Ni_{0.34}Co_{0.08}Mn_{0.5}O₂, referred to as AS200, but the first metal oxide 122 and the second metal oxide 123 are not formed.

### Comparative Example 2—3 nm TiO₂/AS200 Electrode

The electrode of the present comparative example is similar to that of Example 1, wherein the cathode material 121 comprises Li_{1.08}Ni_{0.34}Co_{0.08}Mn_{0.5}O₂, referred to as AS200, the second metal oxide 123 is a 3 nm-thick of TiO₂ thin film, but the first metal oxide 122 is not formed.

### Comparative Example 3—5 nm TiO₂/AS200 Electrode

The electrode of the present comparative example is similar to that of Example 1, wherein the cathode material 121 comprises Li_{1.08}Ni_{0.34}Co_{0.08}Mn_{0.5}O₂, referred to as AS200, the second metal oxide 123 is a 5 nm-thick of TiO₂ thin film, but the first metal oxide 122 is not formed.

### Comparative Example 4—3 nm Al₂O₃/AS200 Electrode

The electrode of the present comparative example is similar to that of Example 1, wherein the cathode material 121 comprises Li_{1.08}Ni_{0.34}Co_{0.08}Mn_{0.5}O₂, referred to as AS200, the first metal oxide 122 is a 3 nm-thick of Al₂O₃ thin film, but second metal oxide 123 is not formed.

### Comparative Example 5—5 nm Al₂O₃/AS200 Electrode

The electrode of the present comparative example is similar to that of Example 1, wherein the cathode material 121 comprises Li_{1.08}Ni_{0.34}Co_{0.08}Mn_{0.5}O₂, referred to as AS200, the first metal oxide 122 is a 5 nm-thick of Al₂O₃ thin film, but the second metal oxide 123 is not formed.

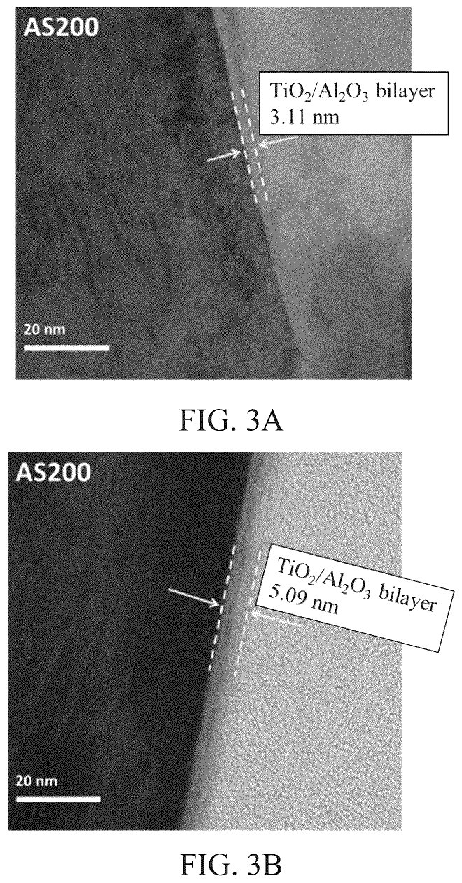

FIG. 3A and FIG. 3B respectively show the TEM image of the cathode material layer of Example 1 and Example 2. Upon examination, it can be observed a well-defined boundary and the absence of lattice fringes on the surfaces of both samples. The preferred structure design involves the utilization of island-like Al₂O₃ as the bottom layer, with subsequent deposition of TiO₂ on top. This arrangement facilitates gradual merging of the two layers, resulting in a smooth surface, as shown in FIG. 3A and FIG. 3B.

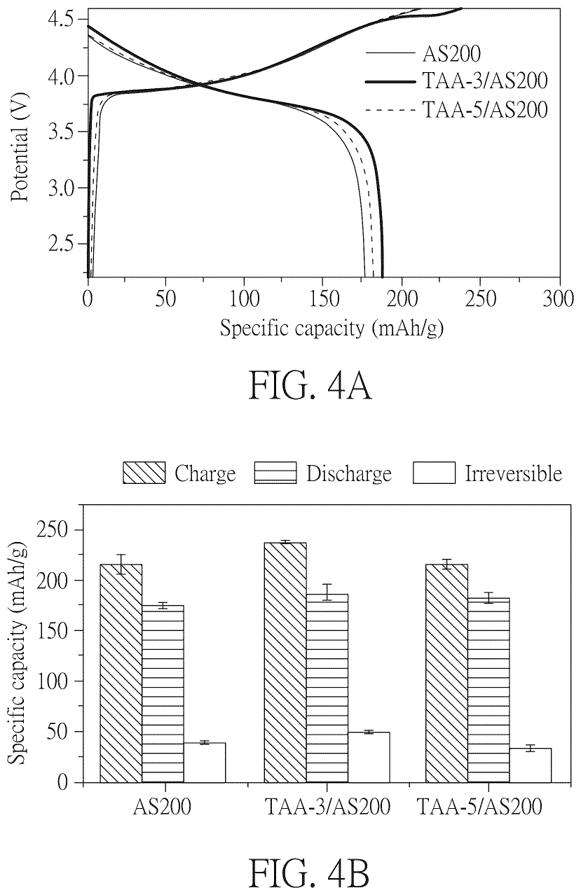

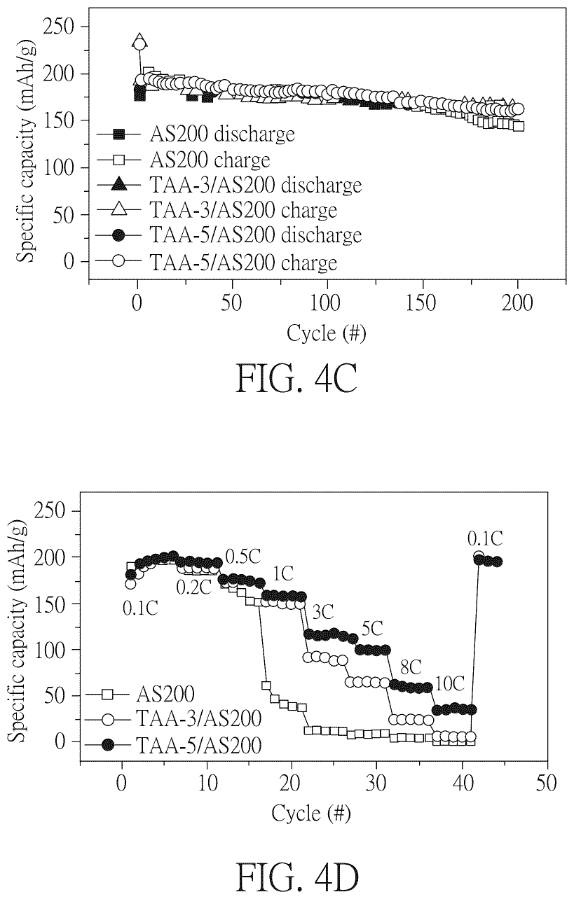

FIG. 4A presents the initial charge capacity of the AS200, TAA-3/AS200, and TAA-5/AS200 electrodes at 0.1C (216, 239, and 216 mAh g⁻¹, respectively). The slightly reduced capacities in the TAA-5/AS200 electrodes can be attributed to the insulating nature of the coating. The initial charge/discharge curves for all three samples exhibit a slope region (3.9-4.36 V) associated with lithium-ion extraction and Ni²⁺ oxidation to Ni⁺⁴. It was known that when the voltage stays above 4.5 V for a long time, lithium ions are removed from AS200 to cause the formation of Li₂MnO₃. This will result in a significant loss of battery capacity and induces MnO₂ impurity. The application of the TiO₂/Al₂O₃ bilayer to AS200 results in an improved discharge capacity. The TAA-3/AS200 and TAA-5/AS200 electrodes demonstrate higher discharge specific capacities of 188 and 182 mAh g⁻¹, respectively, compared to the pristine samples (176 mAh g⁻¹), as shown in FIG. 4B. FIG. 4C shows the cycling performance of these samples under a current density of 0.1C over 200 charge-discharge cycles. Notably, all TiO₂/Al₂O₃ bilayer-coated AS200 electrodes exhibit better specific discharge capacities and enhanced capacity retention compared with the pristine samples. Particularly noteworthy are the results for the TAA-3/AS200 samples, which demonstrate outstanding capacity retention (~86%) and a specific discharge capacity of 162 mAh g⁻¹, surpassing the performance of the pristine samples (~72% and 143 mAh g⁻¹, respectively).

FIG. 4D demonstrates that the TAA series electrodes reveal markedly better C rate performance than AS200. At a rate of 0.5C, the performance of all samples is comparable. However, at 1C, the capacity of the TAA-3/AS200 and TAA-5/AS200 electrodes reaches 149 and 156 mAh g⁻¹, respectively, significantly surpassing the 39 mAh g⁻¹ measured for AS200 at 1C. This enhanced rate capability is believed to stem from the facile Li transport facilitated by the ALD-deposited layers. Reversible Li⁺ ion intercalation into LLO typically occurs through two-dimensional pathways. The ALD layer serves as a Li⁺ ion pathway, offering additional intercalation sites for Li⁺ ions in LLO, ultimately increasing battery capacity and supporting higher energy density.

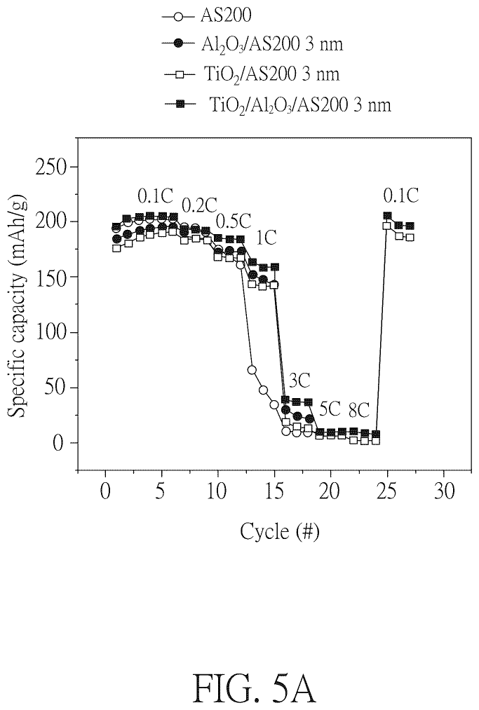

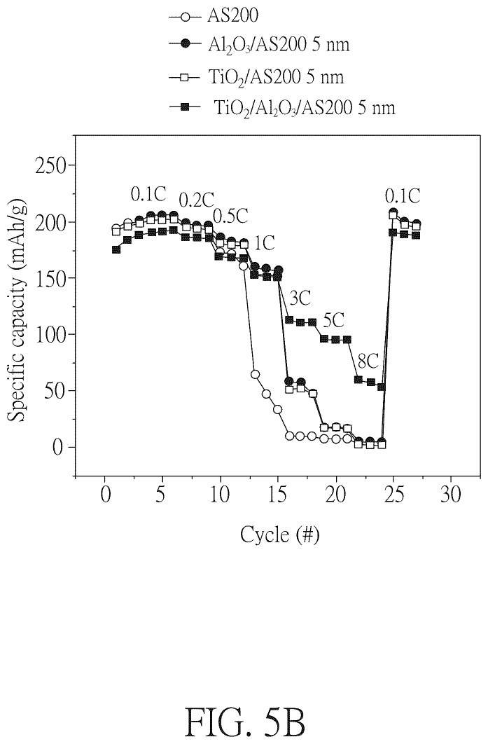

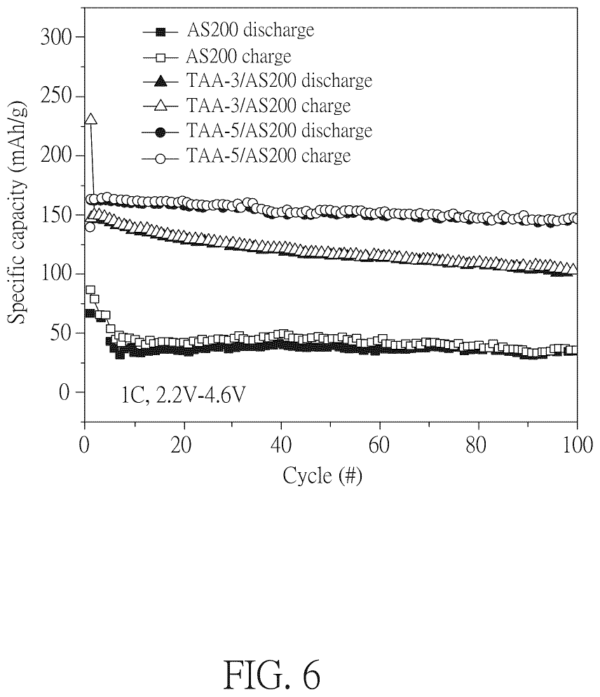

Furthermore, the rate performance for single-layer samples (TiO₂/AS200 and Al₂O₃/AS200, Comparative examples 2 to 5) have been verified and are shown in FIG. 5A and FIG. 5B. Comparing them, TAA-coated samples exhibit better results, potentially attributed to fewer surface defects, such as pinholes, occurring on the electrode surface. Additionally, the cycling performance of TAA-coated samples under a current density of 1C with 100 charge-discharge cycles has been confirmed and is shown in FIG. 6. The capacity retention after cycling for AS200, TAA-3, and TAA-5 electrodes is 52.5%, 70.6%, and 90.4%, respectively.

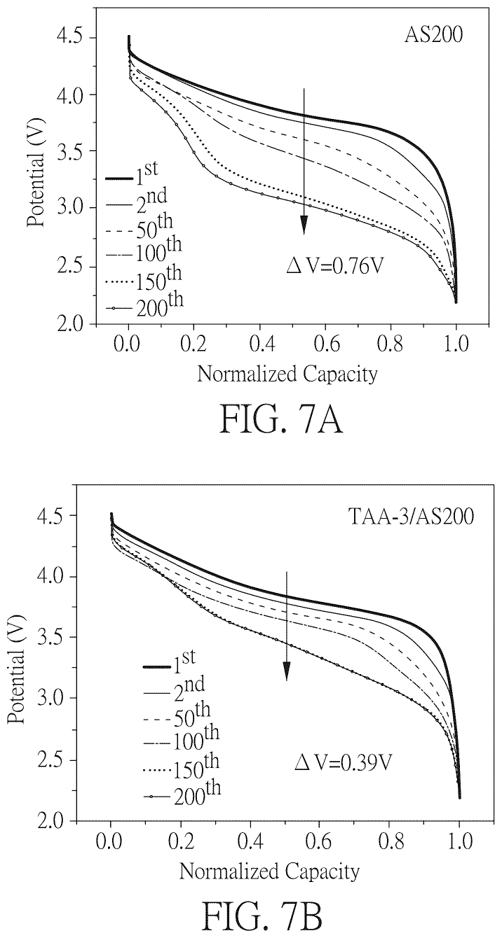

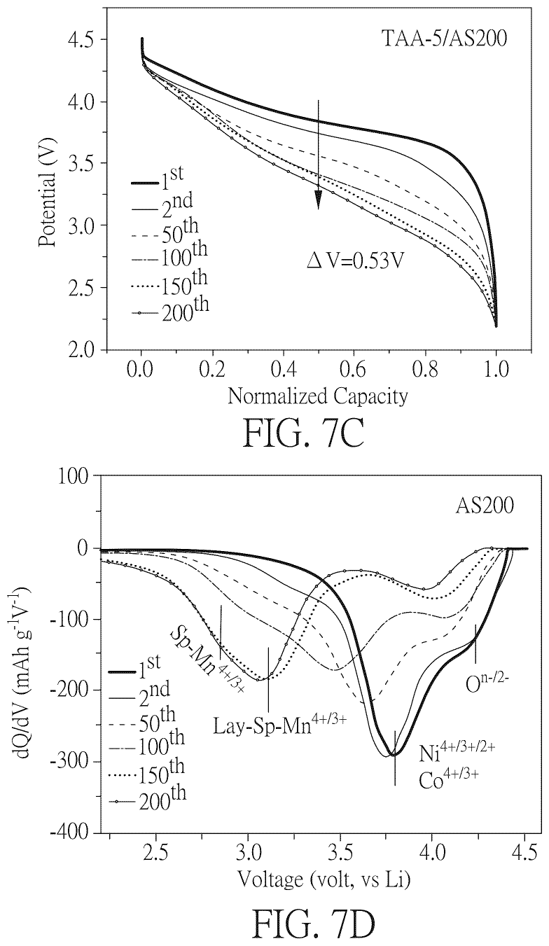

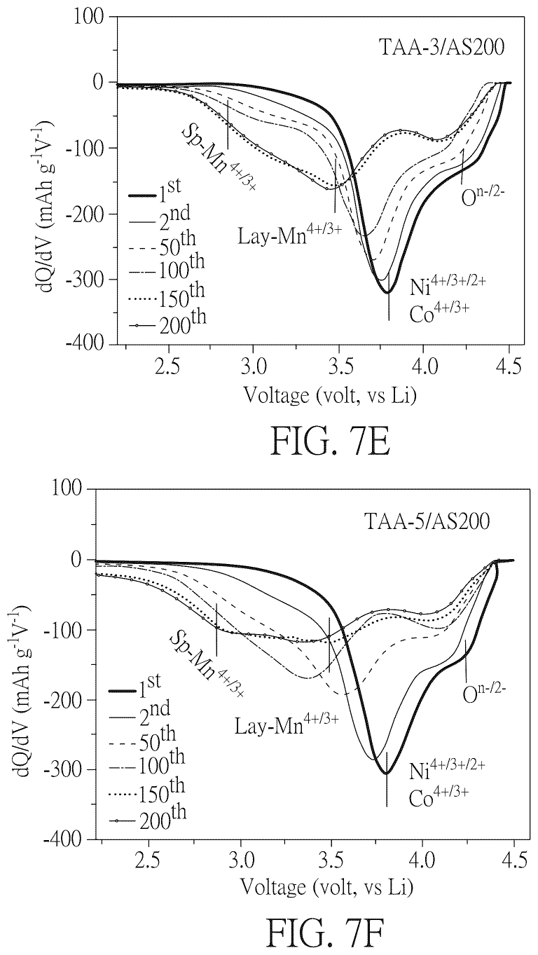

FIG. 7A to FIG. 7C display the voltage vs normalized capacity of the investigated electrodes at 0.1C rate over many cycles. The TAA series electrodes demonstrate better stability, which is evident in their resistance to voltage decay as observed in the evolution of their discharge profiles over 200 cycles. While all electrodes exhibited noticeable voltage decay in the long cycle, the AS200 electrode experienced increasingly severe decay with continued cycling. Specifically, the midpoint discharge voltage (MPV) of the AS200 electrode decreased by 760 mV, whereas the MPV of TAA-3/AS200 and TAA-5/AS200 electrodes decreased by only 390 and 530 mV, respectively.

To better understand the observed voltage fade, we analyzed the dQ/dV plots of the samples with various cycles, as shown in FIG. 7D to FIG. 7F. During the initial discharge cycle, a significant reduction peak is evident in all samples, occurring between 3.7 and 4.4 V. This peak corresponds to the reduction of Ni⁴⁺ to Ni³⁺/Ni²⁺, Co⁴⁺/Co³⁺, and Oⁿ⁻/O²⁻. As the charge-discharge cycles progress to 150 cycles, these reduction peaks only slightly weaken and shift to a lower potential. Surprisingly, in the AS200 electrode, all reduction peaks nearly vanish after 150 cycles and a strong peak at 3 V emerges. This peak is associated with the reduction of Mn from 4+ to 3+ in the layered oxide with spinel-like structures. In contrast, in the TAA-3/AS200 and TAA-5/AS200 electrodes, the shift in the reduction peak is less pronounced, halting at around 3.4 V. This corresponds to the reduction of Mn⁴⁺ to Mn³⁺ in layered structures. Additionally, a minor peak at around 2.8 V is observed in all samples, linked to the reduction of Mn⁴⁺ in the layered oxide with stronger spinel features. These results indicate that the transformation of the layered to spinel phases during cycling is more prohibited for the TAA series samples, resulting in less voltage fade and capacity loss.

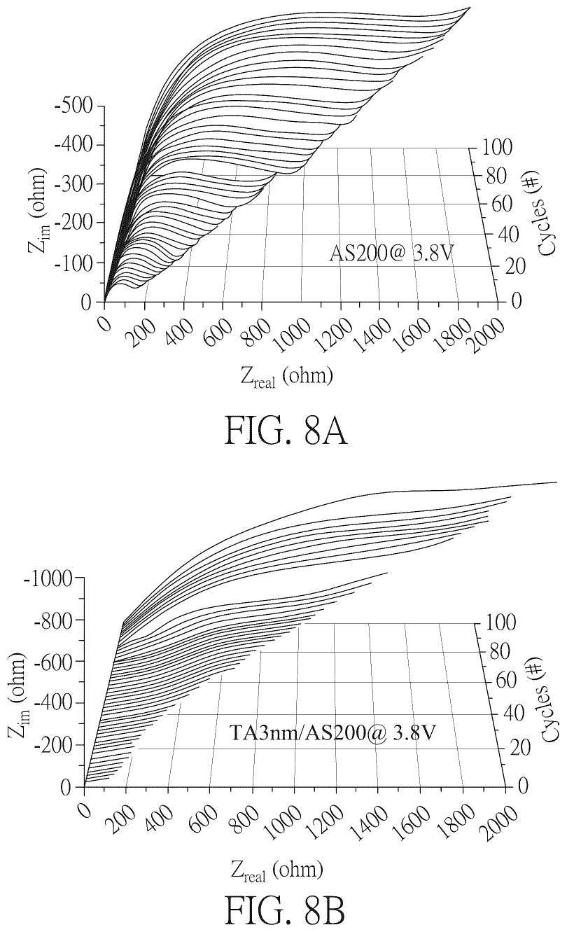

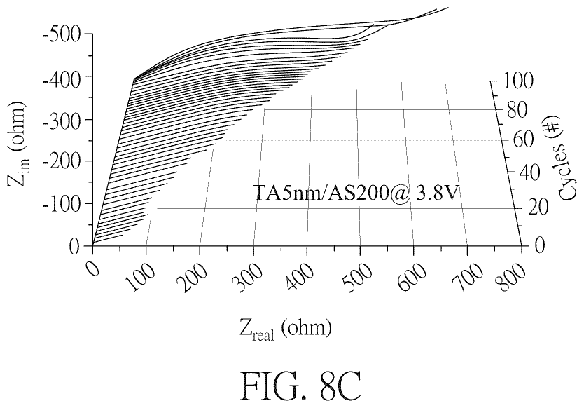

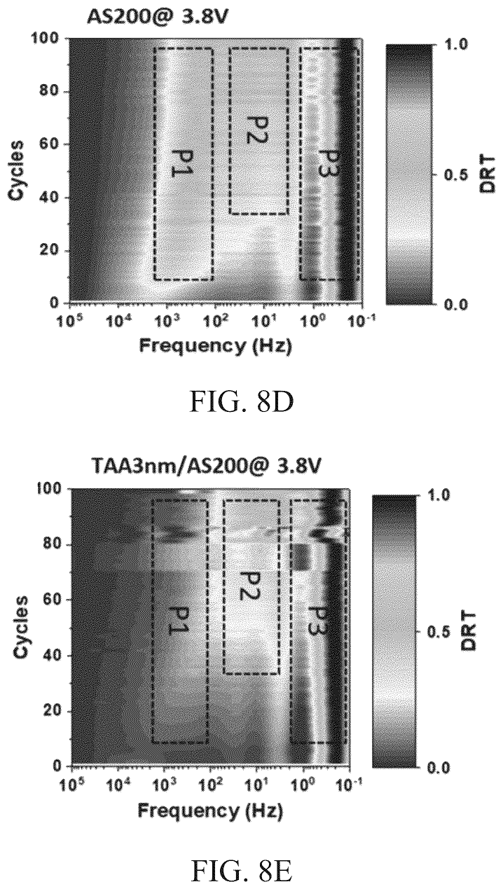

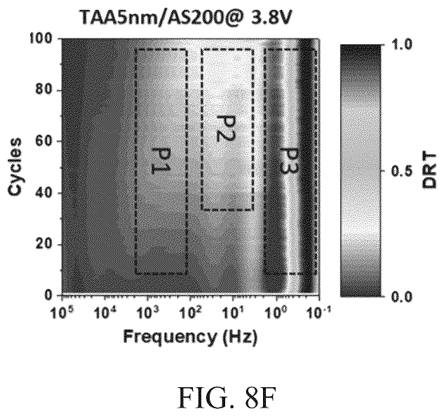

To gain more insight into the interfacial properties between the electrode and electrolyte, we carried out electrochemical impedance spectroscopy (EIS) measurements in the frequency range of 100 kHz to 0.1 Hz at MPV (3.8 V) after activation with 0.1C for 3 cycles. The results are shown in FIG. 8A to FIG. 8C. All electrodes exhibit a compressed semicircle in the high-frequency region and an inclined line in the low-frequency region suggest that the electrochemical process is primarily influenced by charge transfer at the electrode/electrolyte interface and Li⁺ ion diffusion. Furthermore, a noticeable reduction in charge-transfer resistance was observed in the high-frequency semicircle of the TAA series electrode compared to that of the AS200 electrode. However, after 100 cycles, although the total impedance values of batteries with TAA series electrodes increased significantly, they remain much smaller than those with AS200 electrodes. To further understand the observed results, we conducted the distribution of relaxation time (DRT) analysis based on the impedance responses. The DRT derived from all the impedance data were mapped out, as shown in FIG. 8D to FIG. 8F. These plots revealed three distinct signatures around the frequency regions of 103 Hz (P1), 10 Hz (P2), and 1 Hz (P3) respectively. P1 can be attributed to the surface film resistance resulting from Li-ion migration through the electrode surfaces, P2 to the electrode/electrolyte interfacial charge transfer resistances, and P3 to the active material/current collector interfacial charge transfer and solid diffusion. Upon comparing the plots of all samples, it is evident that the signatures P1 and P2 in the AS200 electrode are much brighter than in the TAA series electrode, indicating a higher resistance of surface film and interfacial charge transfer resistances in the AS200 electrode. The relatively minor variation in impedance observed in the TAA series electrode is due to the ability of the TiO₂/Al₂O₃ bilayer coating to mitigate changes in the electrode/electrolyte interface in cycling. The slightly higher resistance of the coated material is associated with the smaller contact area between the active material and the electrolyte after the TiO₂/Al₂O₃ bilayer coating. Consequently, the TAA series electrode displayed fewer structural changes, lighter grain coarsening, and smaller fluctuations in the impedance during cycling. These characteristics signify the efficient mitigation of discharge voltage fading through the TiO₂/Al₂O₃ bilayer coating.

The significant drop in surface film impedance observed in the results indicates less intense electrolyte decomposition in the TAA series electrode. This phenomenon is closely related to the protective shielding effect of the TiO₂/Al₂O₃ bilayer, preventing from direct contact between AS200 active material and the electrolyte.

### Example 3—TiO₂/Al₂O₃/NCM333 5 nm

As shown in FIG. 2, the cathode material 121 comprises Li₁Ni_{1/3}Co_{1/3}Mn_{1/3}O₂, referred to as NCM333. The first metal oxide 122 is a 2.5 nm-thick of Al₂O₃ thin film. The second metal oxide 123 is a 2.5 nm-thick of TiO₂ thin film.

### Comparative Example 6—NCM333 Electrode

The electrode of the present comparative example is similar to that of Example 3, wherein the cathode material 121 comprises Li₁Ni_{1/3}Co_{1/3}Mn_{1/3}O₂, referred to as NCM333, but the first metal oxide 122 and the second metal oxide 123 are not formed.

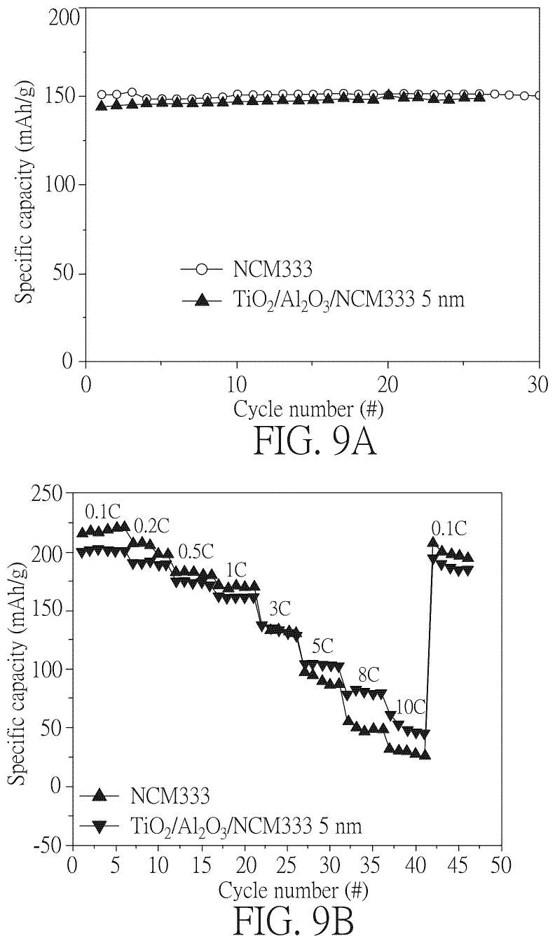

FIG. 9A shows the cycling performance of these samples of Example 3 and Comparative example 6. FIG. 9B shows the rate performance of these samples of Example 3 and Comparative example 6. The results indicates that sample of Example 3 has better C performance than the sample of Comparative example 6. The capacity retention after cycling for the samples of Example 3 and Comparative example 6 are shown in the following Table 1.

TABLE 1

| | Comparative example 6 | Example 3 |
|---|---|---|
| | NCM333 | TiO₂/Al₂O₃/NCM333 5 nm |
| 3 C | 61.7% | 65.7% |
| 5 C | 40.6% | 51.2% |
| 10 C | 12.8% | 23.9% |

### Example 4—TiO₂/Al₂O₃ 2:1 LNMO Electrode

As shown in FIG. 2, the cathode material 121 comprises LiNi_{0.5}Mn_{1.5}O₄, referred to as LMNO. The first metal oxide 122 is a 1.7 nm-thick of Al₂O₃ thin film. The second metal oxide 123 is a 3.4 nm-thick of TiO₂ thin film.

### Comparative Example 7—LMNO Electrode

The electrode of the present comparative example is similar to that of Example 4, wherein the cathode material 121 comprises LiNi_{0.5}Mn_{1.5}O₄, referred to as LMNO, but the first metal oxide 122 and the second metal oxide 123 are not formed.

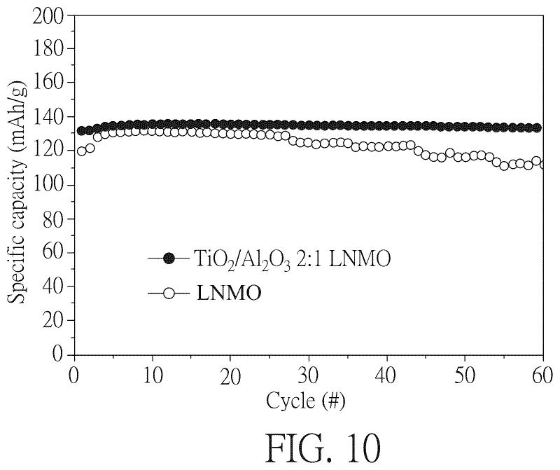

FIG. 10 shows the cycling performance of these samples of Example 4 and Comparative example 7. The results indicates that sample of Example 4 has better C performance than the sample of Comparative example 7.

In summary, the TiO₂/Al₂O₃ bilayer coatings not only preserved the structural integrity of the cathode material but also significantly enhanced its electrochemical performance. The coated electrodes exhibited superior capacity retention, enhanced rate capability, and improved stability, making them promising candidates for high-performance lithium-ion batteries. These findings underscore the effectiveness of ALD coatings in optimizing the surface properties of electrode materials, paving the way for the development of advanced energy storage devices.

Although the present disclosure has been explained in relation to its embodiment, it is to be understood that many other possible modifications and variations can be made without departing from the spirit and scope of the disclosure as hereinafter claimed.

1. A lithium oxide cathode for a lithium-ion battery, comprising:
a current collector; and
a cathode material layer disposed on the current collector and comprising a cathode material, a first metal oxide deposited on the cathode material, and a second metal oxide deposited on the first metal oxide,
wherein the cathode material is a lithium oxide cathode material, the first metal oxide comprises Al₂O₃, and the second metal oxide comprises TiO₂, V₂O₅, ZrO₂, ZnO or a combination thereof.

2. The lithium oxide cathode of claim 1, wherein the second metal oxide comprises TiO₂.

3. The lithium oxide cathode of claim 1, wherein a thickness of the first metal oxide ranges from 0.5 nm to 5 nm.

4. The lithium oxide cathode of claim 1, wherein a thickness of the second metal oxide ranges from 0.5 nm to 5 nm.

5. The lithium oxide cathode of claim 1, wherein the lithium oxide cathode material is a lithium nickel manganese cobalt oxide or a lithium nickel manganese oxide.

6. The lithium oxide cathode of claim 1, wherein the cathode material is Li_{1.08}Ni_{0.34}Co_{0.08}Mn_{0.5}O₂.

7. The lithium oxide cathode of claim 1, wherein the cathode material is Li₁Ni_{1/3}Co_{1/3}Mn_{1/3}O₂.

8. The lithium oxide cathode of claim 1, wherein the cathode material is LiNi_{0.5}Mn_{1.5}O₄.

9. The lithium oxide cathode of claim 1, wherein the cathode material further comprises a conductive additive.

10. The lithium oxide cathode of claim 9, wherein an amount of the conductive additive ranges from 1 wt % to 10 wt % based on a total weight of the cathode material.

11. A lithium-ion battery, comprising:
a lithium oxide cathode, comprising:
a current collector; and
a cathode material layer disposed on the current collector and comprising a cathode material, a first metal oxide deposited on the cathode material, and a second metal oxide deposited on the first metal oxide,
wherein the cathode material is a lithium oxide cathode material, the first metal oxide comprises Al₂O₃, and the second metal oxide comprises TiO₂, V₂O₅, ZrO₂, ZnO or a combination thereof;
an anode disposed opposite to the lithium oxide cathode;
a separator disposed between the lithium oxide cathode and the anode; and
an electrolyte disposed between the lithium oxide cathode and the anode.

12. The lithium-ion battery of claim 11, wherein the second metal oxide comprises TiO₂.

13. The lithium-ion battery of claim 11, wherein a thickness of the first metal oxide ranges from 0.5 nm to 5 nm.

14. The lithium-ion battery of claim 11, wherein a thickness of the second metal oxide ranges from 0.5 nm to 5 nm.

15. The lithium-ion battery of claim 11, wherein the lithium oxide cathode material is a lithium nickel manganese cobalt oxide or a lithium nickel manganese oxide.

16. The lithium-ion battery of claim 11, wherein the cathode material is Li_{1.08}Ni_{0.34}Co_{0.08}Mn_{0.5}O₂.

17. The lithium-ion battery of claim 11, wherein the cathode material is Li₁Ni_{1/3}Co_{1/3}Mn_{1/3}O₂.

18. The lithium-ion battery of claim 11, wherein the cathode material is LiNi_{0.5}Mn_{1.5}O₄.

19. The lithium-ion battery of claim 11, wherein the cathode material further comprises a conductive additive.

20. The lithium-ion battery of claim 19, wherein an amount of the conductive additive ranges from 1 wt % to 10 wt % based on a total weight of the cathode material.
